(19) United States
(12) Patent Application Publication
(10) Pub. No.: US 2014/0012775 A1
(43) Pub. Date: Jan. 9, 2014

(54) PROCESS CONTROL SYSTEM

(71) Applicant: ABB TECHNOLOGY AG, Zurich (CH)

(72) Inventors: Alexander KAISER, Heddesheim (DE); Benjamin Danzer, Mannheim (DE); Daniel Grossmann, Schriesheim (DE)

(21) Appl. No.: 13/935,814

(22) Filed: Jul. 5, 2013

(30) Foreign Application Priority Data
Jul. 6, 2012 (DE) 202012006550.5

(51) Int. Cl. G06Q 30/02

(52) U.S. Cl. CPC G06Q 30/0282
USPC 705/347

(57) ABSTRACT

Exemplary embodiments relate to a process control system for the automated control of the process-engineering installations with a device management system, wherein the process control system includes at least one central facility and also a plurality of field devices. The device management system includes at least one function for integrating a field device into the process control system. For the purpose of transmitting experiences of the users to the system provider, at least one component of the process control system includes a user interface for rating the integration solution, capturing the rating, and transmitting the rating from the user to a system provider for evaluation.

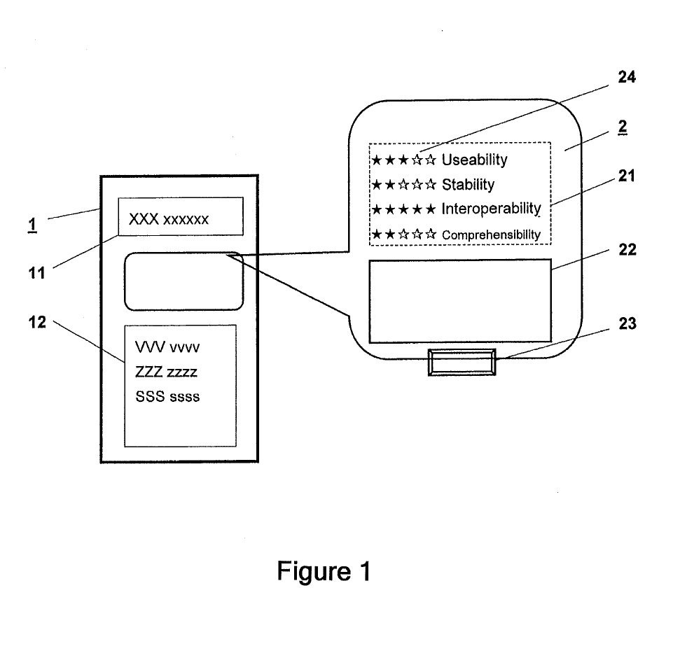

### RELATED APPLICATION

This application claims priority under 35 U.S.C. §119 to German application DE 202012006550.5 filed in Germany on Jul. 6, 2012, the entire content of which is hereby incorporated by reference.

### FIELD

The disclosure relates to a process control system for the automated control of the process-engineering installations with a device management system.

### BACKGROUND

Known process control systems can include (e.g., comprise) at least one central facility and also a plurality of field devices. The field devices can be arranged close to the process—in the field—and include means (e.g., sensor) for capturing a physical process variable sensors or means (e.g., actuator) for influencing a physical process variable, the sensors or actuators being connected to the at least one central facility and being controlled by this central facility. By way of example, a process control system of the generic type is described in EP 0 597 561.

Furthermore, the sensors or actuators known practices equip process control systems with a device management system, which can include various tools from different technologies. These tools can, for example, include device descriptions that are familiar to a person skilled in the art from the terms Field Device Tool (FDT), Device Type Manager (DTM), Electronic Device Description (EDD) and Field Device Integration (FDI), or any other suitable tool as desired. These tools form device type representatives that are able to contain the device capabilities, the parameters and the dependencies thereof, but also implementations of user interfaces. The user interfaces may be designed for viewing and modifying device parameters or for initiating specific device functions.

These device type representatives are usually delivered or provided by the device manufacturer and then imported or installed into a process control system. As soon as they are installed or imported, it is possible to form specific device instances of this type in order to present a specific measurement location in the process control system.

These tools furthermore facilitate the integration of field devices into the process control system by virtue of properties of the respective field device being available in preconfigured form in a defined description language or device application. Device management systems of this type are described in http://de.wikipedia.org/wiki/FDT/DTM and http://de.wikipedia.org/wiki/Device_Description_Language, for example.

The quality of the integration mechanisms in relation to stability, robustness, user friendliness and interoperability with other components is very different and furthermore dependent on the specific topology of the process control system.

The user of the process control system and also of the respective integration solution and of the management system is tied to the capabilities and the quality of the respective system without being able to report problems that occur to the system provider. On the other hand, the system provider is prevented from adequately responding to defects or errors in a faulty system or the components thereof. There is accordingly a need for the experiences of the users to be transmitted to the system provider in a suitable manner.

### SUMMARY

An exemplary process control system for the automated control of process-engineering installations with a device management system is disclosed, the process control system comprising: at least one central facility; and a plurality of field devices connected to the at least one central facility; wherein the device management system has at least one integration solution function for integrating a field device into the process control system via the at least one central facility; and wherein at least one component of the process control system is configured to: a) provide a user with an interface for rating the integration solution, b) capture the user rating, and c) transmit the user rating to a system provider for evaluation.

### DESCRIPTION OF THE DRAWINGS

The disclosure and also further advantageous refinements and improvements and further advantages will be explained in more detail and described by means of the drawing which illustrates an exemplary embodiment of the disclosure and in which:

The single FIGURE shows an integratable system component of a process control system at the level of a device management system, in accordance with an exemplary embodiment of the present disclosure.

### DETAILED DESCRIPTION

Exemplary embodiments of the present disclosure improve known process control systems such that the experiences of the users are transmitted to the system provider in system-integrated fashion.

According to an exemplary embodiment described herein, at least one component of the process control system has the following properties:
a) providing the user with a user interface for rating the integration solution,
b) capturing the rating from the user, and
c) transmitting the rating from the user to the system provider for evaluation.

Advantageously, the user of the process control system and also the components thereof is part of the device management system since the report from said user to the system provider is integrated in the maintenance of the process control system as a quality criterion. Therefore, the system provider is able to check and improve the quality of its products in line with the ratings from the users and to inform suppliers and partners about potential improvements where specified. This renders the system provider able to improve the reliability of its devices and facilities and of the devices and facilities delivered by third parties and to increase the life of the automation solution as a whole.

Furthermore, solutions provided by exemplary embodiments described herein perform the integration of system components more smoothly and more reliably, since the system provider is informed about problems in the system integration in real time and on a specific basis.

Incompatibilities can be quickly identifiable, which means that the relevant devices can be blocked on a type-selective basis.

According to another exemplary embodiment of the present disclosure, provision is made for standardized rating of the integration solution. In this case, a limited number of rating levels is provided that is expediently oriented to familiar rating systems. In an exemplary implantation of this embodiment, the standardization may include a five-level rating scale in the manner of school marks—best assessment for the smallest unit—or in the manner of a hotel rating—best rating for the largest unit.

The user can be provided with a simple and straightforward instrument for rating the integration solution that does not call for any kind of training for the user and can be used spontaneously.

According to yet another exemplary embodiment of the present disclosure, the standardized rating has a multilevel structure. In this case, the structuring is dependent on the structure of the system components and maps the technology thereof in a specific manner.

Individual aspects of the integration solution of the exemplary embodiment described herein can thus be rated independently in dedicated fashion. This prevents a faulty sub-aspect of the integration solution from resulting in a negative rating for the overall solution.

According to another exemplary embodiment, the standardized rating is complemented by a free text field. This exemplary feature can provide the user with the opportunity to verbally complement his rating and to describe the experiences he has had in the event of a problem.

As shown in the FIGURE, the device management system of the process control system includes (e.g., comprises) a device library 1, also called a device catalog, which maps the integratable system components 11, for example a device, extensively in terms of its properties 12, version levels, configurations, etc. Each installed or imported device type representative is presented to the user in a list for selection in order to select for instantiation the device type representative that matches the device. In addition, this device library 1 can include at least one function for the system integration of the respective system component.

The device library 1 can also include at least one function for the user to rate 2 the system integration. The user has thus produced instances based on the installed type that represent specific measurement locations in his installation. For each of these specific measurement locations, there is a physical device 11, installed in the installation, which the user configures, monitors, and diagnoses using the means from the installed device representative.

The user then uses the delivered software, the user interface, and the descriptions of the device capabilities that the device manufacturer has compiled.

When the user has completed his work (or during the work), he is able to have an opinion about the product delivered by the device manufacturer with regard to the integration properties of said product, such as—but not exclusively—usability, stability, performance, comprehensibility. These integration properties are arranged on a prescribed scale of rating levels 24 in the form of a standardized rating 21. The scale is formed from a number of symbols, for example asterisks, that follows the standardization. In this case, the value of the rating is proportional to the number of selected symbols.

In a further refinement of the invention, the function for rating 2 the system integration includes a free text box 22 for verbally complementing the standardized rating and also for describing experiences in the event of problems.

Furthermore, the function for rating 2 the system integration includes operator control means 23 for sending off the rating that has been entered.

The described exemplary embodiments involve a plurality of ratings being provided during various phases of the installation or device life cycle. To this end, provision may be made for each rating to be provided with a time stamp.

The rating is provided for the whole device type representative and can then be transmitted indirectly to the process control system supplier either using a potentially available, direct connection to the process control system supplier or by means of an export to a file or similar mechanisms. The process control system supplier then has the opportunity to act to ensure customer satisfaction.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Device library
11 System component
12 Property
2 Rating
21 Standardized rating
22 Free text box
23 Operator control means
24 Rating levels

What is claimed is:

1. A process control system for the automated control of process-engineering installations with a device management system, the process control system comprising:
at least one central facility; and
a plurality of field devices connected to the at least one central facility;
wherein the device management system has at least one integration solution function for integrating a field device into the process control system via the at least one central facility; and
wherein at least one component of the process control system is configured to:
a) provide a user with an interface for rating the integration solution,
b) capture the user rating, and
c) transmit the user rating to a system provider for evaluation.

2. The process control system as claimed in claim 1, wherein the rating of the integration solution is standardized by a limited number of rating levels.

3. The process control system as claimed in claim 2, wherein the rating of the integration solution has a multilevel structure.

4. The process control system as claimed in claim 2, wherein the standardized rating is complemented by a free text box.

5. The process control system as claimed in claim 3, wherein the standardized rating is complemented by a free text box.
